(19) United States
(12) Patent Application Publication
(10) Pub. No.: US 2021/0149347 A1
(43) Pub. Date: May 20, 2021

(54) HYBRID WATCH PATCH-ANTENNA

(71) Applicant: FESTINA LOTUS, S.A., MADRID (ES)

(72) Inventor: Jian LIU, LUND (SE)

(21) Appl. No.: 17/045,132

(22) PCT Filed: Apr. 3, 2019
(86) PCT No.: PCT/EP2019/058427

§ 371 Date: Oct. 2, 2020

(30) Foreign Application Priority Data
Apr. 3, 2018 (SE) 1850368-0

(51) Int. Cl. G04R 60/12; G04G 21/04; G04G 17/04; H01Q 1/27; H01Q 9/04

(52) U.S. Cl. CPC G04R 60/12; G04G 21/04; H01Q 9/045; H01Q 1/273; G04G 17/04

(57) ABSTRACT

A patch antenna for a hybrid watch (100) and a hybrid watch (100). The hybrid watch comprising at least one transparent face (140), a casing (110), wherein the casing (110) is comprised of a material with a dielectric constant larger than 1.0 and the casing houses an electronics assembly (120), a dial plate (130) and a coupling element with a first coupling terminal and a second coupling terminal. The arrangement is such that one face of the dial plate (130) is at least partly visible through the transparent face (140). The electronics assembly (120) comprises a radio frequency interface (1020) connected to the first coupling terminal of the coupling element. The dial plate (130) comprises a patch antenna having a first face and an opposing second face wherein the patch antenna is arranged to have the first face arranged towards the transparent face and wherein the second face of the patch antenna comprises the second coupling terminal of the coupling element.

### TECHNICAL FIELD

This invention relates to the field of hybrid or smart watches in general, and more specifically to the field of antennas for hybrid or smart watches.

### BACKGROUND

The functionality previously associated with a wristwatch such as telling time, date etc. changed with the introduction of digital watches. Features such as calculators and advanced alarms were added and there was an organic evolution of the functionality until the smart watches were introduced on the market. Smart watches are available in all shapes, sizes and forms including the more classical styles of the hybrid watches.

Common for most hybrid and smart watches is that they are connected watches, i.e. they have some means of, typically wirelessly, connecting to, for instance, a smart phone. Many devices also have the ability to receive GPS data and connect to wireless sensors which is especially common in watches geared towards active users as fitness accessories.

Regardless of the connectivity method implemented in a hybrid or smart watch, there is a need for an antenna. With the antenna comes all the problems associated with incorporation of a radiating element within a limited space. In addition to the purely antenna design related difficulties, there are additional requirements relating to e.g. constraints imposed by the physical design and chosen materials of the hybrid or smart watch. If the radiating element will be used also for transmission of data, regulatory requirements relating to Specific Absorption Ratio, SAR, and body warm might be relevant. The functionality and efficiency of the radiating element will have significant impact on the current consumption of the hybrid or smart watch impacting the battery life of the hybrid or smart watch.

One antenna for a watch is presented in CN103943945 which can be used for communication of GPS/Glonass and BT/WiFi/WLAN. The watch antenna includes antenna parts arranged in the watch. A metal ring/frame is arranged above the antenna as part of the watch. The antenna parts are electrically coupled with the metal ring/frame. The metal ring/frame is used as a main antenna radiation body and arranged at the periphery of the watch. The watch antenna uses the electrically coupled (feed) antenna structure and the metal ring/frame which is electrically coupled with the antenna parts arranged above the antenna parts in the watch and the metal ring/frame is used as the antenna radiation body.

One problem with the prior art is that the antenna require certain constructions, the metal ring/frame of the watch in order to have expected performance. The performance of the antenna will further depend heavily on the load of the metal ring/frame subjected by, for instance, the wrist of a wearer.

### SUMMARY

An object of the present invention is to provide a new type of hybrid watch antenna which is improved over prior art and which eliminates or at least mitigates the drawbacks discussed above. More specifically, an object of the invention is to provide a hybrid watch antenna that is less sensitive to load variations. These objects are achieved by the technique set forth in the appended independent claims with preferred embodiments defined in the dependent claims related thereto.

In a first aspect, a patch antenna 500 for a hybrid watch 100 is provided. The hybrid watch 100 comprises a casing 110, a transparent face 140 and an electronics assembly 120. The electronics assembly 120 comprises a radio frequency interface 1020 and a first coupling terminal 1040. The casing 110 is made of a material with a dielectric constant larger than 1.0. The patch antenna 500 comprises a conductive material and has a first face T and an opposing second face B, and the patch antenna 500 is adapted to be arranged inside the casing 110 of the hybrid watch 100 such that a plane of the faces T, B of the patch antenna 500 is substantially parallel with a plane of the transparent face 140, and the first face T of the patch antenna 500 is facing the transparent face 140. The first coupling terminal 1040 is connected to the radio frequency interface 1020 of the hybrid watch 100 and the second face B of the patch antenna 500 comprises a second coupling terminal 1130 adapted to couple, via a coupling element 1100, to the first coupling terminal 1040.

In one embodiment, the first face T of the patch antenna 500 is comprised in a dial plate 130. This allows for one patch antenna 500 being used with many different shapes, sizes and forms of the dial plate 130.

In one embodiment, the first face T of the patch antenna 500 is a dial plate 130. This will reduce the number of parts comprising the hybrid watch 100.

In one embodiment, the first and the second coupling terminals 1040, 1130 are terminals of the coupling element 1100 and the coupling is capacitive. Further to this, the second face B of the patch antenna 500 is the second coupling terminal 1130 of the coupling element 1100. The capacitive coupling to the patch antenna 500 will increase the bandwidth of the feed compared to e.g. a direct galvanic coupling.

In one embodiment, which is a variant with the capacitive coupler, the first coupling terminal 1040 is further connected to a conductive coupling patch 1110 with a first face 1140 and a second face 1210 wherein the second face 1210 is substantially parallel to and is facing the second face B of the patch antenna 500. The conductive coupling patch 1110 allows for a controlled capacitive coupling and the shape and form of the conductive coupling patch 1110 could be used to e.g. add matching inductance to the coupling element 1100.

In one embodiment of the patch antenna 500 the casing 110 of the hybrid watch 100 is conductive and the patch antenna 500 is adapted to be arranged inside the casing 110 such that a gap 1300 is formed between the conductive material of the patch antenna 500 and the casing 110 so that the conductive material of the patch antenna 500 is galvanically isolated from the casing 110. The gap 1300 will form a radiating slot between the casing 110 and the conductive material of the patch antenna 500. The radiating slot further increases the directivity of the patch antenna 500 and further decreases SAR and body warm.

In one embodiment of the patch antenna 500 with the gap 1300, the gap 1300 comprises a material with a dielectric constant larger than 1.0. Adding a material with a dielectric constant larger than 1.0 will lower the resonance frequency of the patch antenna 500 making it possible to create a lower frequency patch antenna 500 without changing the area of the patch antenna 500.

In one embodiment of the patch antenna 500 with the gap 1300, the width of the gap 1300 is in the range of 0.3 mm to 1.3 mm, preferably 0.4 mm to 1.2 mm, and most preferably 0.5 mm to 1.0 mm. These gap sizes have been shown, through empirical studies on hybrid watches, to result in the best load insensitivity and efficiency.

In one embodiment of the patch antenna 500, the patch antenna 500 further comprises an NFC coil 900 and at least one galvanically isolating material interposed between the first side T of the patch antenna 500 and the NFC coil 900. Having the NFC coil 900 comprised on the first side T of the antenna will control the electromagnetic flux of the NFC coil 900 through the transparent face 140.

In another aspect of the patch antenna 500 with the NFC coil 900, the galvanically isolating material is a ferrite material. The properties of the ferrite material helps to further direct the electromagnetic flux of the NFC coil through the transparent face 140.

In a second aspect, a hybrid watch 100 is provided. The hybrid watch 100 comprises at least one transparent face 140, a casing 110, wherein the casing 110 is comprised of a material with a dielectric constant larger than 1.0 and the casing houses an electronics assembly 120, a dial plate 130 and a coupling element 1100 with a first coupling terminal 1040 and a second coupling terminal 1130. The arrangement is such that one face of the dial plate 130 is, at least partly, visible through the transparent face 140. The electronics assembly 120 comprises a radio frequency interface 1020 connected to the first coupling terminal 1040 of the coupling element 1100. The dial plate 130 comprises a patch antenna 500 having a first face T and an opposing second face B wherein the patch antenna 500 is arranged to have the first face T arranged towards the transparent face 140 and wherein the second face B of the patch antenna 500 comprises the second coupling terminal 1130 of the coupling element 1100.

In one embodiment of the hybrid watch 100, the coupling element 1100 is a capacitive coupling element 1100 and further comprises a conductive coupling patch 1110 with a first face 1140 and a second face 1210. The conductive coupling patch 1110 is arranged between the patch antenna 500 and the electronics assembly 120 such that the second face 1210 of the coupling patch 1110 is substantially parallel to and is facing the second face B of the patch antenna 500 and the first face of the coupling patch 1110 is connected to the first coupling terminal 1040. In this embodiment, the capacitive coupling to the patch antenna 500 will increase the bandwidth of the feed compared to e.g. a direct galvanic coupling.

In one embodiment of the hybrid watch 100, the dial plate 130 is the patch antenna 500. This will reduce the number of parts of the hybrid watch 100.

In one embodiment of the hybrid watch 100, it further comprises an impedance matching circuitry 1030 arranged between the radio frequency interface 1020 and the first coupling terminal 1040. This will allow further flexibility in the design and may be used to further increase radiated efficiency of the hybrid watch 100.

In one embodiment of the hybrid watch 100, the casing 110 of the hybrid watch 100 is conductive and the patch antenna 500 is arranged inside the casing 110 such that a gap 1300 is formed between the patch antenna 500 and the casing 110, so that the patch antenna 500 is galvanically isolated from the casing 110. The gap 1300 forms a radiating slot between the casing 110 and the patch antenna 500. The radiating slot further increases the directivity of the patch antenna 500 and further decreases SAR and body warm.

In one embodiment of the hybrid watch 100 with the gap 1300, the electronics assembly 120 is arranged inside the casing 110 such that the gap 1300 is also formed between the electronics assembly 120 and the casing 110 so that the electronics assembly 120 is galvanically isolated from the casing 110. Extending the gap 1300 will further decrease the load sensitivity of the patch antenna 500.

In one embodiment of the hybrid watch 100 with the gap 1300, the gap 1300 comprises a material with a dielectric constant larger than 1.0. Adding a material with a dielectric constant larger than 1.0 will lower the resonance frequency of the patch antenna 500 making it possible to create a lower frequency patch antenna 500 without changing the area of the patch antenna 500.

In one embodiment of the hybrid watch 100 with the gap 1300, the width of the gap 1300 is in the range of 0.3 mm to 1.3 mm, preferably 0.4 mm to 1.2 mm, and most preferably 0.5 mm to 1.0 mm. These gap sizes have been shown, through empirical studies on hybrid watches, to result in the best load insensitivity and efficiency.

In one embodiment of the hybrid watch 100, the patch antenna 500 further comprises an NFC coil 900 and at least one galvanically isolating material interposed between the first side T of the patch antenna 500 and the NFC coil 900. Having the NFC coil 900 comprised on the first side T of the antenna will control the electromagnetic flux of the NFC coil 900 through the transparent face 140.

In one embodiment of the hybrid watch with the NFC coil, the galvanically isolating material is a ferrite material. The properties of the ferrite material helps to further direct the electromagnetic flux of the NFC coil through the transparent face 140.

### BRIEF DESCRIPTION OF THE DRAWINGS

Embodiments of the invention will be described in the following; references being made to the appended diagrammatical drawings which illustrate non-limiting examples of how the inventive concept can be reduced into practice.

FIG. 1 is an exploded view of a hybrid watch.

FIG. 2 is a top view of a dial plate.

FIG. 3 is a perspective view of a dial plate.

FIG. 4 is a perspective view of a dial plate.

FIG. 5 is a perspective view of a dial plate.

FIG. 6 is a perspective view of a dial plate.

FIG. 7 is a perspective view of a dial plate.

FIG. 8 is a perspective view of a dial plate.

FIG. 9 is a perspective view of a dial plate.

FIG. 10 is a block diagram of an electronics assembly.

FIG. 11A is a perspective view of a coupling element.

FIG. 11B is a perspective view of a coupling element.

FIG. 12 is a perspective view of coupling patches.

FIG. 13 is a perspective view of a casing.

FIG. 14 is an exploded view of a hybrid watch.

FIG. 15 is an exploded view of a hybrid watch.

### DETAILED DESCRIPTION OF EMBODIMENTS

Hereinafter, certain embodiments will be described more fully with reference to the accompanying drawings. The invention may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

For the sake of clarity, a hybrid watch, in the meaning intended in this specification, is a watch comprising a mechanical part and a digital part. The digital part could be arranged to control the mechanical part. The name hybrid watch should not limit the description to a narrow definition of this specific type of watches but should be understood to encompass any kind of e.g. smartwatches, pocket watches, fitness bands, smart bracelets, connected watches, general wearable devices such as compasses, belt buckles and key chain device.

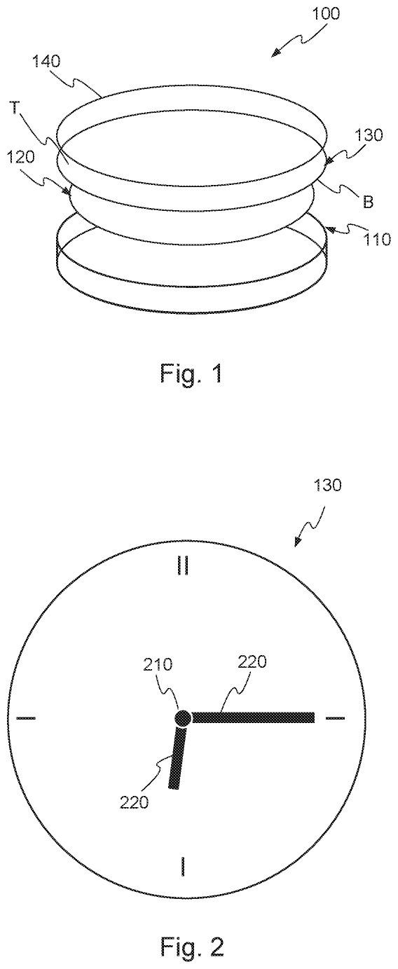

With reference to FIG. 1 a hybrid watch 100 is shown. The hybrid watch 100 comprises a casing 110 of a material with a dielectric constant larger than 1.0. The hybrid watch 100 has an electronics assembly 120 and a dial plate 130 having a first face T and a second face B. The hybrid watch 100 further comprises a transparent face 140. The transparent face 140 may be of any transparent material e.g. different kinds of plastic or glass. The arrangement of the hybrid watch 100 is such that the first face of the dial plate is at least partly visible through the transparent face. Note that the substantially cylindrical casing 110 shown in FIG. 1 is just one embodiment, the casing 110 may have any shape suitable for a hybrid watch e.g. elliptical, square, rectangular, hexagonal, octagonal shapes, etc.

As shown in FIG. 2 the dial plate 130 may further have at least one hole 320 adapted to receive for instance a shaft 210 that may hold for instance one or more hands 220. The dial plate 130 may have additional holes adapted to receive further shafts making the dial plate 130 comprise e.g. more than one set of hands comparable to that of e.g. chronograph watches. The dial plate 130 may also have additional openings to allow for other features e.g. one or more date windows or simply to reveal internal features comparable to that of e.g. skeleton watches. Furthermore, there may be other reasons for adding holes 320 such as for e.g. fastening or galvanic connection. It should be understood that the dial plate 130 may comprise one or more digital displays, and the hands, if any, may be e.g. graphical representations on the digital display.

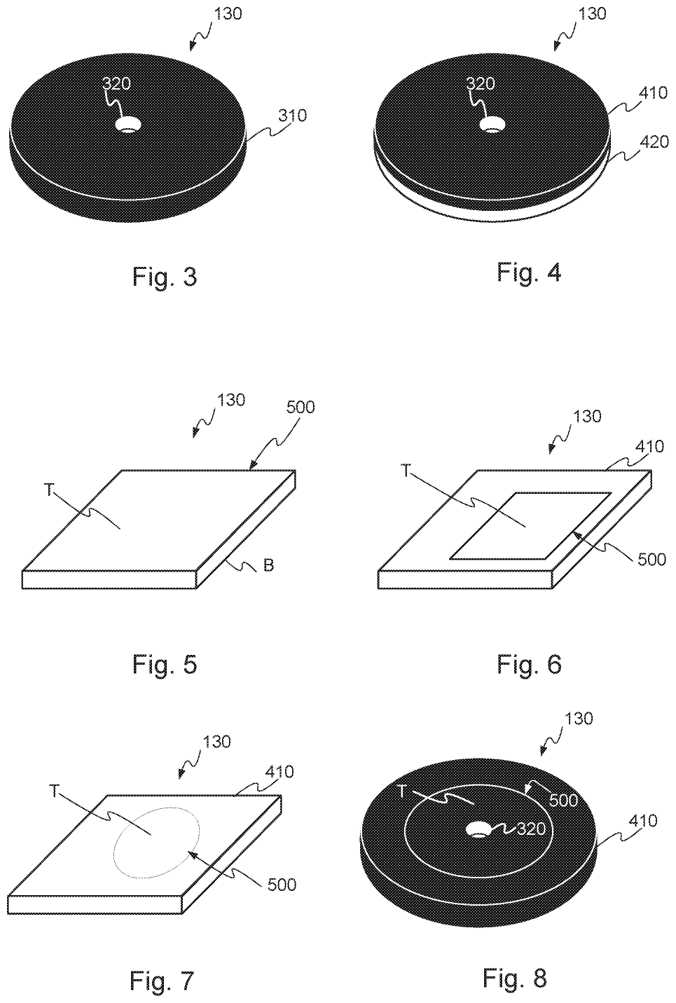

The dial plate 130 may, as shown in FIG. 3 be solid, i.e. made from a single material 310 or a mix of materials. The dial plate 130 may, as shown in FIG. 4, be a stacked structure with a first material 410 and a second material 420. The materials 310, 420, 430 may be different materials and either of the materials may be a conductive material such as e.g. metal. It is plausible that not all structures of the different materials have the same shape and, for instance, the first material may have a smaller area than the second material or vice versa. Further, any paint, film, ornamentation such as numbers or symbols may either be considered as a separate material or be comprised by any of the other materials 310, 410, 420 forming the dial plate 130. It is evident for the skilled person that the number of materials comprising the dial plate 130 can be numerous and the combination of conductive and non-conductive materials may be stacked in any order desirable. It should also be mentioned that the term stack could relate to items just being placed on top of one another without any binding material, or items bound together by for instance adhesives or different layers in a Printed Circuit Board, PCB. If the arrangement of the dial plate is such that at least one of the materials 310, 410, 420 is a conductive material, that material may be used as a patch antenna 500.

FIG. 5 illustrates a patch antenna 500 where the dial plate 130 is the patch antenna 500. If the material 310 in FIG. 3 is conductive and suitable for a patch antenna 500, the dial plate 130 shown in FIG. 3 works as a patch antenna 500 in the same way as the square patch antenna 500 depicted in FIG. 5. The patch antenna 500 of FIG. 5 has a first face T and a second face B where the first face T is adapted to face the transparent face 140 of the smart watch 100.

As shown in FIG. 6, FIG. 7 and FIG. 8, the patch antenna 500 may be arranged to only cover part of the dial plate 130, and the shape of the dial plate 130 and the patch antenna 500 may be of any imaginable shape, size or form suitable for being comprised in the dial plate 130 of a hybrid watch 100.

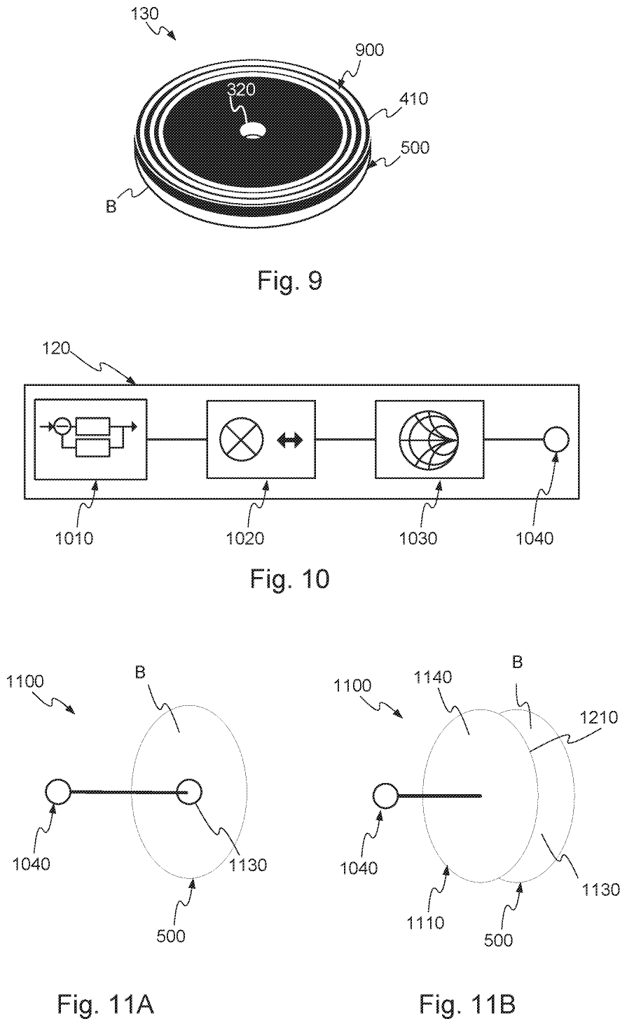

In FIG. 9, another version of the dial plate 130 also suitable for any hybrid watch 100 is shown. In this version the dial plate 130 has a Near Field Communication (NFC) antenna coil 900, hereafter denoted NFC coil 900 for short, stacked on top of the first material 410 and the patch antenna. In this version, the first material 410 may be an insulating material adapted to affect electromagnetic flux of certain frequencies, such as e.g. a ferrite material. The ferrite material decreases the coupling between the NFC coil 900 and the patch antenna 500. This will in turn reduce eddy currents induced by the magnetic flux of the NFC coil 900 on the patch antenna 500, thereby increasing the efficiency of the NFC coil 900. By selecting the type of ferrite material based on its permeability value and thickness, optimal performance is achievable. In this case, the magnetic flux generated by the NFC coil 900 would be comparable to that generated by NFC coil 900 in a free space environment, i.e. the load of the patch antenna is virtually removed. The NFC coil 900 may be implemented on e.g. a PCB, a flexible Printed Circuit Board (FPC), or as a wire wound coil or stamped metal sheet. On top of the NFC coil 900 the dial plate 130 may comprise e.g. a plate or a film (not shown in FIG. 9) of a non-conductive, substantially non-transparent material, e.g. plastics, ceramics etc., that covers the NFC coil from view through the transparent face 140 of the hybrid watch 100. This plate may be arranged to form numbers, letter, symbols, pictures or any kind or artistic work suitable for a hybrid watch 100. The same arrangement with the substantially non-transparent material may of course also be utilized with in all variants of hybrid watches 100 in general and dial plates 130 in particular, regardless if they utilize an NFC coil 900 or not.

It is evident for the skilled person that almost unlimited variations of the dial plate 130 can be made and not all can be covered in this disclosure. Rather a subset of variations giving an introduction to the possibilities and configurability of the dial plate 130 is offered. For instance, the patch antenna depicted in FIG. 5 may have its first face T visible through the transparent face and arranged to form numbers, letters, symbols, pictures or any kind or artistic work suitable for a hybrid watch 100.

FIG. 10 depicts the electronics assembly 120. The electronics assembly comprises a controller 1010 in communication with a radio frequency interface 1020 connected to an optional impedance matching circuitry 1030, which in turn is connected to the first coupling terminal 1040 of a coupling element 1100. The controller 1010 may be comprised of e.g. stand-alone electronics, integrated circuitry and/or a microcontroller executing relevant program instructions. The controller 1010 may be in communication with the radio frequency interface 1020 through e.g. a serial interface such as SPI or any other digital communications interface. The controller 1010 and the radio frequency interface 1020 may also be comprised in the same physical package, e.g. a System In Package (SIP), or on the same silicon die as one Integrated Circuit (IC) and their mutual communication adapted accordingly. The radio frequency interface 1020 may be arranged to, e.g. modulate, generate, receive and de-modulate high frequency radio signals according to one or more communication protocols, e.g. Bluetooth, WiFI, cellular, ANT+, Z-Wave, IEEE802.15.4 etc., modulation schemes such as OOK, FSK, QAM, PSK, GMSK etc. and spectrum access techniques, e.g. TDMA, CDMA, FDMA, OFDM, FHSS etc. The radio frequency interface 1020 may comprise any number of filters, switches and couplers needed to perform communication over a desired radio protocol.

The output impedance of the radio frequency interface 1020 may be adapted before it is connected in the first coupling terminal 1040 and, in this case, the impedance matching circuitry 1030 may be arranged between the radio frequency interface 1020 and the first coupling terminal 1040. The impedance matching circuitry 1030 may be realized in numerous ways, e.g. different combinations and numbers of reactive components such as coils and/or capacitors but also LTCC, transmission lines, integrated circuitry or active arrangements may be used. The first coupling terminal 1040 may comprise a first end of e.g. a capacitive coupler, a direct feed, a coaxial cable, a transmission line, a pad, a plated patch, a Laser Direct Structuring (LDS), element an FPC, RF spring or a pogo-pin. The electronics assembly 120 may be arranged, or partly arranged, on one or more Printed Circuit Boards (PCB) or FPCs. The electronics assembly may also be realized as an IC, SOC, sub assembly module or combinations of all these or any other assembly methods. Further to the blocks depicted in FIG. 10 the electronics assembly 120 may comprise any of or all of NFC circuitry, a vibrator, an accelerometer, a user control interface means e.g. a push button, switch or touch sensitive element, various sensors e.g. barometer, Magnetoresistive (MR), Heart Rate Monitor (HRM) etc., a power source, a microphone, a speaker module, a persistent information storage means such as a flash memory, a non-persistent information storage means such as a Random Access Memory, RAM, power management etc. The skilled person will realize that there might be more components, blocks and methods to implement the electronics assembly 120 of a hybrid watch 100 having further optional functionality, but these are all commonly known and not necessary for the skilled person to realize the hybrid watch 100 as described herein. Such a component may be one or more motors arranged to e.g. drive the shaft 210 connected to the one or more hands 220.

In FIG. 11A and FIG. 11B, an overview of a coupling element 1100 is shown. With reference to FIG. 11A, the coupling element comprises the second side B of the patch antenna 500 with a second coupling terminal 1130. The first coupling terminal 1040 connects to the second coupling terminal by e.g. a direct feed, a coaxial cable, a transmission line, a pad, a plated patch, a Laser Direct Structuring (LDS) element an FPC or a pogo-pin. The second coupling terminal 1130 could be, in the case of for instance a pogo-pin or RF spring, be implemented as e.g. a gold plated area of the second side B of the patch antenna 500. The feed type utilized by the coupling element of FIG. 11A may be described as a direct feed. In FIG. 11B, the coupling element 1100 is modified by the introduction of a conductive coupling patch 1110. The conductive coupling patch 1110 comprises a first face 1140 and a second face 1210, and the first face 1140 is arranged to be connected to the first coupling terminal 1040 in similar ways as described earlier. The coupling element is arranged in such a way that the second face 1210 of the conductive coupling patch 1110 faces the second side B of the patch antenna 500 which means that the second side B of the patch antenna 500 will double as the second coupling terminal 1130. The conductive coupling patch 1110 and the patch antenna 500 may be configured to be arranged in substantially parallel planes such that they, at least partly, overlap. The patches may be of any shape or form and should of course not be restricted to be planar but could be e.g. bent or curved patches. The coupling element 1100 shown in FIG. 11B may be described as a capacitive coupling element.

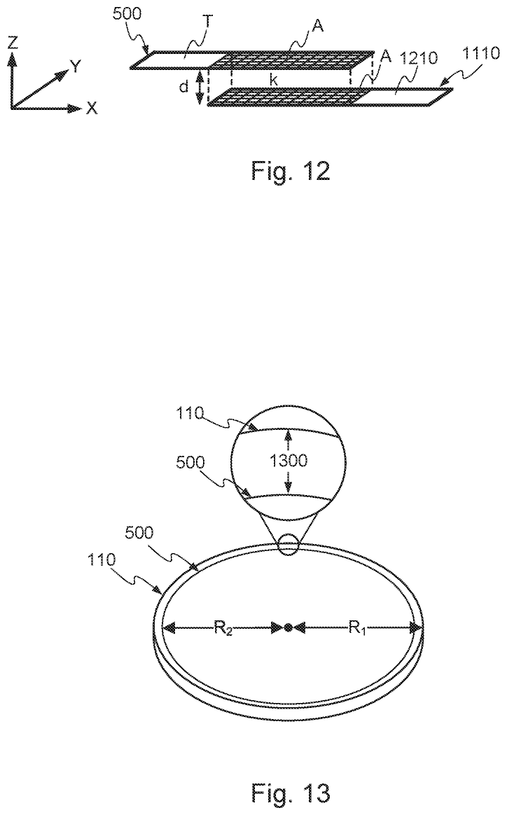

One example of the coupling element 1100, wherein the coupling effect is mainly capacitive, is best described with reference to FIG. 12. In FIG. 12, the two patches, a version of the conductive coupling patch 1110 and the patch antenna 500 of FIG. 11B are placed, for ease of understanding, in a coordinate system with three axis, an X-axis a Y-axis and a Z-axis. The patches 500, 1110 are placed in a plane described by the X-axis and the Y-axis but are offset with reference to the Z-axis. A section where the patches 500, 1110 overlap, in the X-Y-plane, forms an area A in meters squared, m², where the second face 1210 of the conductive patch 1110 overlaps, or is overlapped by, the patch antenna 500. A distance d, on the Z-axis, in meters, m, between the overlapping areas A may be defined as substantially the parallel distance between the conductive patches 1110, 500. The volume created by the overlapping area A and the distance d may be filled with a material having a relative permittivity or dielectric constant k. In this arrangement, there is a capacitive coupling between the conductive patches 1110, 500 with a capacitance C in farad, F, which may be estimated by Eqn. 1:

$$C = \frac{k \cdot {ɛ}_{0} \cdot A}{d} \qquad Eqn . 1$$

In Eqn. 1 the term Co denotes the permittivity of space in farads per meter, F/m. The coupling element 1100 has an impedance Z that may, in a simplified way, be described as a function of a lowest operating frequency fin Hertz, Hz, as Eqn. 2:

$$Z = \frac{1}{2 \cdot π \cdot f \cdot C} \qquad Eqn . 2$$

The coupling element 1100 may be designed to have as high coupling factor as possible, or analogously, as low impedance as possible, thereby minimizing the insertion loss of the coupling element 1100. This can be related to the physical dimensions d, A of the coupler 1100 by combination of Eqn. 1 and Eqn. 2 as shown in Eqn. 3:

$$\frac{k \cdot {ɛ}_{0} \cdot A}{d} = \frac{1}{2 \cdot π \cdot f \cdot Z} \text{<=>} \frac{d}{A} = k \cdot {ɛ}_{0} \cdot 2 \cdot π \cdot f \cdot Z \qquad Eqn . 3$$

As mentioned, an increased coupling factor will reduce the insertion loss associated with coupling signals from the first coupling terminal 1040 to the second coupling terminal 1130. The discussion disclosed above is valid for all embodiments of the coupling element 1100 with capacitive coupling properties suitable for a hybrid watch 100. The coupling element 1100 may also, in some variation of the embodiments of the hybrid watch 100, be arranged to have the second coupling terminal 1130 connect from a second conductive coupling patch to the second side B of the patch antenna 500. Embodiments of the hybrid watch wherein a coupling element with capacitive coupling properties is used to feed the patch antenna 500 from the electronics assembly 120 may be said to utilize a patch antenna 500 with a capacitive feed.

In some designs of hybrid watches 100 it is desirable to have the patch antenna 500 galvanically isolated from the casing 110. This may be the case if e.g. the casing is made of a conductive material such as metal, but mandatory only when the casing 110 is, from an electromagnetic radiation perspective, sealed. The isolation is optional if there are other openings for the electromagnetic radiation e.g. a non-conductive casing 110 or back cover 1440, openings in dial plate 130, casing 110 or back cover 1440. The galvanic isolation may be achieved by an arrangement as the one shown in FIG. 13. In FIG. 13 the casing 110 has a radius of R₁ and the patch antenna 500, which may be comprised in the dial plate 130, has a radius of R₂ where R₁>R₂ forming a gap 1300 between the casing 110 and the patch antenna 500 with a width of R₁-R₂. A similar arrangement is plausible between for instance the electronics assembly 120 and the casing 110. The gap may be formed between the patch antenna 500 and the casing 110, thus allowing other materials 410, 420 of the dial plate 130 to be in connection with the casing e.g. the radius of these materials may be made larger than that of the patch antenna 500. If more than one material of the dial plate 130 is conductive, one of which is the patch antenna 500, it may be desirable to have all conductive materials galvanically isolated from the casing 110. The gap 1300 may also be achieved by shaping the patch antenna 500 differently from the casing 110 in other aspects than the radius, for instance the curvature or shape. The gap 1300 may be arranged such that it is not visible through the transparent face 140, which may be achieved e.g. by the casing 110 visually covering the gap 1300 or by having a substantially non-transparent layer comprised in the dial plate 130 covering the gap 1300.

The gap 1300 may be arranged such that the gap 1300 forms a radiating slot between the casing 110 and patch antenna 500. Such an arrangement increases the directivity of the patch antenna 500 in the direction through the transparent face 140, basically forming a cavity backed patch antenna. The increased directivity is beneficial when e.g. the Specific Absorption Radio, SAR, values or body warm effects of the hybrid watch 100 should be reduced.

Another positive effect that may be achieved by the gap 1300 is that the radiating slot formed by the gap 1300 can be seen as a parasitic element acting as a slot antenna. When the casing is loaded by e.g. a hand or wet cloth covering or contacting the casing 110 or hybrid watch 100 exterior, the detuning will be subjected to the parasitic slot antenna rather than the patch antenna 500. In reality this means that the impedance locust, when viewed in a Smith chart, of the input impedance of the patch antenna 500 will be reduced. I.e. it will concentrate around the input impedance, thus actually increasing the bandwidth of the patch antenna 500. In the opposite case, when the patch antenna is subjected to the load, the resonance frequency of the patch antenna 500 will be changed causing a detuning of the patch antenna 500.

In the case with a conductive casing 110, the casing 110 may be arranged to be galvanically isolated from both the electronics assembly 120 and the patch antenna 500. Otherwise the conductive casing may act as a parasitic to the patch antenna 500 loading the patch antenna and thus reducing the lowest operating frequency f. Further to this, the patch antenna 500 may be less sensitive to variations of the load of the casing, e.g. if the hybrid watch is on a wrist, has a metal bracelet etc. compared to if the casing is connected to the electronics assembly 120 or the patch antenna 500.

It may also be possible to have the electronics assembly comprise more than one radio frequency interface 1020, each having different lowest operating frequencies f. One radio frequency interface 1020 may be arranged to feed the patch antenna 500 according to any variant of the hybrid watch 100 where the casing 110 is conductive, another radio frequency interface 1020 may be arranged to feed the casing 110 in any way described herein, e.g. through a capacitive or direct feed. This arrangement would result in a multi-band antenna structure with for instance the patch antenna 500 is arranged to resonate at frequencies suitable to receive GPS signals and the casing 110 is arranged to resonate at frequencies suitable to transmit and receive Bluetooth communications.

In any embodiment with a conductive casing 110, there is the option of connection the casing to electric ground which may be the same as the negative terminal of the battery. Such an arrangement would allow the gap 1300 to become a true slot antenna with the patch being one pole and the casing 100 the other pole. It is likely that the width of the gap 1300 would have to be increased in order to get comparable results to the galvanically isolated casing 110, but the arrangement may offer improved resilience toward Electro Magnetic Discharge, ESD.

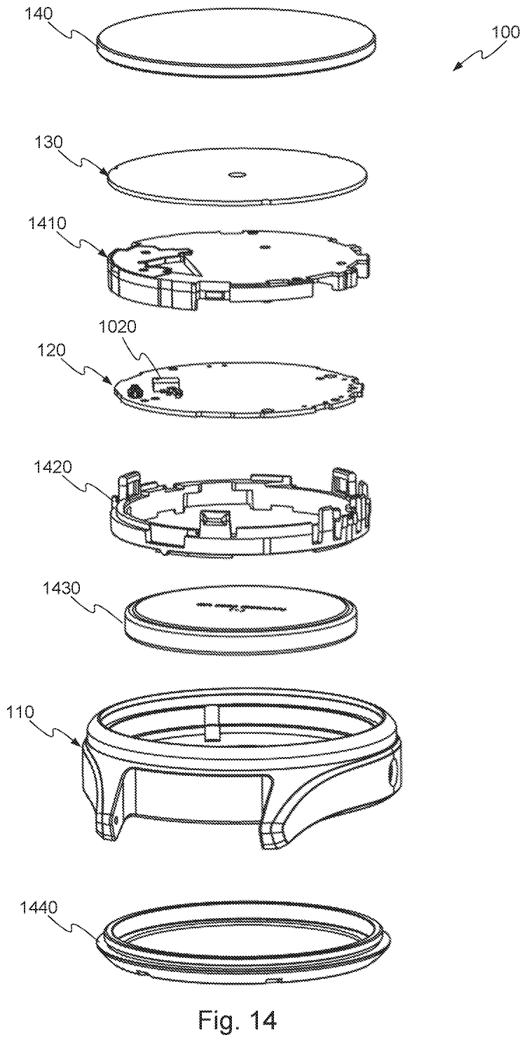

FIG. 14 illustrates an example of the hybrid watch 100 with some additional optional features such as a dial plate carrier 1410, an assembly carrier 1420, a battery 1430 and a back cover 1440. The dial plate carrier 1410 may be used to arrange the dial-plate 130 inside the casing 110 and also to orchestrate a connection between the patch antenna 500, comprised in the dial plate 130, and the electronics assembly 120 by means of coupling the first coupling terminal 1040 in the electronics assembly 120 to the second coupling terminal 1130 in the patch antenna 500. This coupling could be accomplished in any way described in this disclosure e.g. by capacitive coupling or direct coupling where some variants may comprise the conductive coupling patch 1110. The dial plate carrier 1410 may further be used to ensure a correct gap 1300 between the casing 110 and the patch antenna 500 and be made of a material having a dielectric constant larger than 1.0, in order to decrease the lowest operating frequency f of the patch antenna 500. Further to this, the dial plate carrier 1410 may assist in ensuring a clearance between e.g. protruding elements on the electronics assembly 120 and the patch antenna 500. The assembly carrier 1420 may be used to arrange the electronics assembly 120 and the battery 1430 in such a way that an electric connection is achieved between the battery 1430 and the electronics assembly 120. The assembly carrier 1420 may further help position, for instance, the battery and the electronics assembly inside the casing 110 and the positioning may further be achieved in a, with regards to the electronics assembly and the casing, galvanically isolated manner. Isolation between the casing 110 and the battery 1430 may also be desirable and this can also be achieved by the assembly carrier. The assembly carrier may be made in any material, but a material with a dielectric constant larger than 1.0 can be used to reduce the lowest operating frequency f of the patch antenna 500. The dial plate carrier 1410 and the assembly carrier 1420 may be adapted to lock together in a manner to control the relative vertical distance between all parts positioned by the respective carriers 1410, 1420. The combination of the carriers 1410, 1420 may allow the creation of a core module assembly comprising the electronics assembly 120, the coupling element 1100 and the patch antenna 500. Such a core module assembly would allow for usage of the same core module in different designs of casings 110 and dial plates 130. Either one, or both of, the dial plate carrier 1410 and the assembly carrier may be part of the casing 110 e.g. if it is desirable to reduce the number of parts of the hybrid watch 100. The casing 110 of the hybrid watch 100 may further have a back cover 1440 which may enable for instance battery 1430 replacements and service. The fixation of the back cover in the casing 110 may be achieved by for instance a threaded arrangement or a snap-in construction and may be done in a way so as to ensure water resistance or water protection of the interior of the hybrid watch 100. The back cover 1440 may be of the same material as the casing 110 but may alternatively be made from any other suitable material including transparent material. Note that although the hybrid watch 100 shown in FIG. 14 shows a battery 1430 as power source, other power sources may be used, such as e.g. a self-winding rotor mechanism similar to those used in automatic quartz watches.

In one variant of the hybrid watch 100, the electronics assembly 120 and the radio frequency interface 1020 are arranged, substantially as shown in FIG. 1, inside a casing 110 made of a non-conductive material with a dielectric constant greater than that of air. The dial plate 130 is made of copper and also works as a patch antenna 500. The first face T of the patch antenna 500 may be painted such as to have logos, numbers or other artwork suitable for the face of a hybrid watch. The first coupling terminal 1040 of the electronics assembly 120 is comprised by a pogo-pin or RF-spring mounted on a PCB of the electronics assembly 120. The first coupling terminal 1040 connects directly to the second face B of the patch antenna, thus feeding the patch antenna. This embodiment may be further enhanced by an impedance matching circuitry 1030 between the first coupling terminal 1040 and the radio frequency interface 1020.

Another variation may have a non-conductive plate comprising logos, numbers or other artwork suitable for the face of a hybrid watch in place of, or in addition to, the paint on the first face T of the patch antenna 500. An NFC coil 900 may be arranged between the first face T of the patch antenna 500 and the non-conductive plate in a manner not causing galvanic connection between the patch antenna 500 and the NFC coil 900. The galvanic isolation may be achieved by e.g. a non-conductive adhesive film on the side of the NFC coil 900 that is arranged towards the patch antenna 500, an isolating coating on the patch antenna 500 or the NFC coil 900, all may be in combination with a ferrite sheet. The patch antenna 500 may also comprise at least one hole 320 or opening that can be used to connect the NFC coil 900 to an NFC circuitry of the electronics assembly 120. There may be further holes 320 both in the patch antenna 500, the non-conductive plate and the NFC coil 900, such that e.g. a shaft 210 could be arranged through the hole 320, and the shaft 210 may hold one or more hands 220.

A slightly different variant may be achieved by having first coupling terminal 1040 of the electronics assembly 120 arranged as e.g. a pad or a plated area on a PCB or FPC. In this variant a connection means such as a pogo-pin or RF-spring may be arranged to connect from the second face B of the patch antenna to the coupling terminal 1040 of the electronics assembly. The RF-spring or pogo-pin may be fixated by e.g. soldering or by having the RF-spring or pogo-pin being part of a dial plate carrier 1410.

In order to avoid limiting the bandwidth of the patch antenna 500 the embodiments presented may be altered to use a capacitive coupler as the coupling element 1100. The capacitive coupler may be achieved e.g. by allowing the coupling element 1100 to be at least partly comprised by the patch antenna 500. This may be done by e.g. using the second face B of the patch antenna as the second conductive coupling patch. In this case, the second coupling terminal 1130 is comprised in the patch antenna. The conductive coupling patch 1110 may be accomplished by for instance a conductive foil, plate, PCB of FPC arranged between the dial plate carrier 1410 and the electronics assembly. The first coupling terminal 1040 may be implemented in line with the previously disclosed examples connecting to the first coupling terminal 1040. The distance d between the second face 1210 of conductive coupling patch 1110 and the second face B of the patch antenna 500 may be decided by the thickness of the dial plate carrier 1410 if the dial plate carrier 1410 is interposed between the conductive coupling patch 1110 and the patch antenna 500, it may also be that the conductive coupling patch is arranged between the patch antenna 500 and the dial plate carrier 1410, or between the patch antenna and the electronics assembly 120 if no dial plate carrier 1410 is used. In this case the distance d will be minimized and the conductive coupling patch 1110 may be e.g. an FPC with an insulating cover layer arranged towards the second side B of the patch antenna to ensure that there is no galvanic connection between the conductive coupling patch 1110 and the patch antenna 500. Dimensioning the coupler may be done by utilizing Eqn. 3 to minimize the impedance Z by modifying the d/A ratio, or by changing the material between the conductive patches to one with a different relative permittivity k. Since the design of the hybrid watch 100 might be constraining modifications to the area A, the material and thickness of the dial plate carrier may be used to optimize the coupling element 1100 according to e.g. Eqn. 3.

It should be noted that any variant of the hybrid watch 100 wherein a coupling element 1100 with a capacitive coupling mechanism is utilized may be implemented in virtually any shape, size or form suitable for a hybrid watch 100. The shape of the conductive coupling patch 1110 may be varied in order to create various additional effect. An extended, widthwise narrow, optionally bent, curved or otherwise shaped, conductive coupling patch 1110 will introduce series inductance which may be used to further improve the matching and bandwidth of the patch antenna 500. Alternatively, or additionally, stubs could be introduced in e.g. the conductive coupling patch 1110 in order to introduce parallel parasitic capacitance and/or inductance. I.e. a carefully designed conductive coupling patch 1120 may be used to achieve antenna tuning on coupler level and additionally to create multiple resonances of the patch antenna 500 in order to add more frequency bands and/or increase bandwidth of the patch antenna 500 even further.

In another embodiment, which may be a variant of any of the other listed examples, the casing 110 is made of a conductive material. In this example, a galvanic isolation may be needed between the patch antenna 500 and the casing 110 in order to, for example, achieve load insensitivity of the patch antenna 500. The galvanic isolation may have the additional effect of increasing the directivity of the patch antenna 500, thus decreasing negative effects such as SAR and body warm. The casing 110 will in this embodiment allow the patch antenna 500 to act as cavity backed patch antenna if a gap 1300 is formed between the casing 110 and the patch antenna 500. As mentioned earlier, the gap may be controlled with, for instance, the assistance of the dial plate carrier 1410 or by having a non-conductive material of the dial plate 130 extend beyond the patch antenna 500 ensuring galvanic isolation between the casing 110 and the patch antenna 500. Empirical studies of the antenna performance in a hybrid watch have shown that, for an antenna with a lowest operating frequency of 2400 MHz, a gap 1300 in the range of 0.3 mm to 1.3 mm is acceptable, a gap 1300 in the range of 0.4 mm to 1.2 mm is preferred, and a gap 1300 in the range of 0.5 mm to 1.0 mm is most preferred.

In embodiments with an NFC coil 900 wherein the casing 110 is conductive, it may further be required to have galvanic isolation between the NFC coil 900 and the casing 110. This may preferably be accomplished simply by keeping the maximum radius of the NFC coil 900 smaller than that of the dial plate 130. Alternatively, the NFC coil 900 may have the same or larger radius as the dial plate 130 and e.g. the dial plate carrier may be used to ensure galvanic isolation between the NFC coil 900 and the casing 110. As another option, the NFC coil 900 may extend beyond the patch antenna 500 and optionally cover, at least partly, the gap 1300, and having materials with non-conductive properties encompassing the NFC coil 900. This may e.g. be achieved by implementing the NFC coil 900 on an FPC and allowing a slight, e.g. 0.1 mm, guard distance between the outermost trace of the coil and the edge of the FPC. An additional un-routed layer may be added to either side of the FPC, thereby achieving isolation also in a vertical direction. If the casing 110 is non-conductive it may be preferable to maximize the radius of the NFC coil 900 in order to enhance performance of the NFC coil 900.

In the case with a conductive casing 110, it may be preferable to ensure a galvanic isolation also between the electronics assembly 120 and the casing 110 as well as between the battery 1430 and the casing 110. This galvanic isolation may be achieved e.g. by use of an assembly carrier 1420 or by allowing an additional isolation area on the outskirts of for instance a PCB or FPC carrying the electronics assembly 120. Further to this, the battery 1430 may also be arranged to be isolated from the optional back cover 1440, also this may be achieved by the assembly carrier 1420.

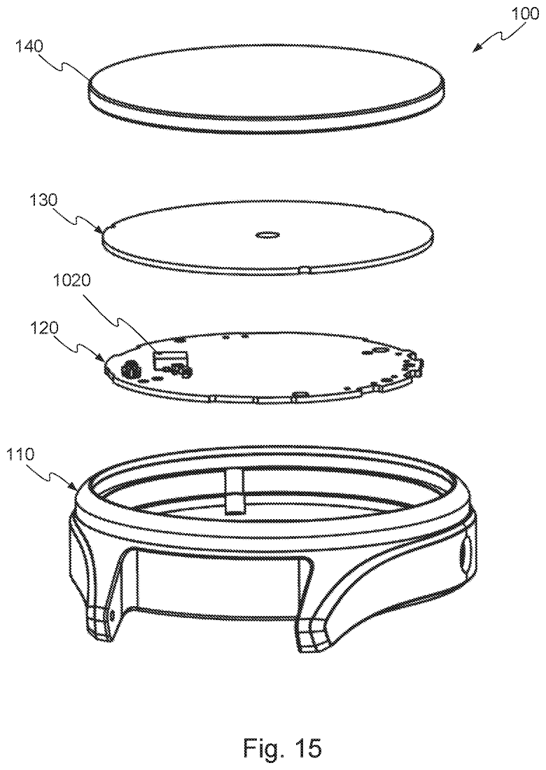

In FIG. 15 a hybrid watch 100 is shown that may be the basis for any other variant listed in this disclosure. The hybrid watch 100 comprises one transparent face 140 and a casing 110 made of a material with a dielectric constant larger than 1.0. The casing 110 houses an electronics assembly 120, a dial plate 130 and a coupling element 1100 (not shown in FIG. 15, please refer to e.g. FIG. 11A, FIG. 11B or FIG. 12) with a first coupling terminal 1040 and a second coupling terminal 1130. The coupling element 1100 may be implemented in any form, shape or size mentioned herein. The arrangement inside the casing 110 is such that one face of the dial plate 130 is, at least partly, visible through the transparent face 140. As mentioned earlier, the electronics assembly 120 comprises a radio frequency interface 1020 connected to the first coupling terminal 1040 of the coupling element 1100. The dial plate 130 comprises the patch antenna 500 (not shown in FIG. 15, please refer to e.g. FIG. 6-FIG. 8) having a first face T and an opposing second face B. The patch antenna 500 is arranged to have the first face T arranged towards the transparent face 140 and the second face B of the patch antenna 500 comprises the second coupling terminal 1130 of the coupling element 1100.

As a design example, assume a design project with the goal of designing a hybrid watch 100 with certain design requirements. The hybrid watch 100 should operate in the 2400 MHz Industrial Scientific and Medical (ISM) band using Bluetooth to connect to for instance a mobile phone and also have NFC functionality. Industrial designers of the project has finalized the design of the casing 110 and specified the material choices of the casing 110. The inner radius R₁ of the casing 110 is the same as that of the dial plate 130 which is made of plastic and is specified to be 14.7 mm and the material of the casing 110 is a conductive metal. The cost of the hybrid watch should be minimized, e.g. the number of components should be kept at a minimum. Designing an antenna for this design would put constraints of performance but using the disclosed designs, it is straight forward to design a cavity backed patch antenna 500.

Prior to the invention of this disclosure, the project would have had to trade off design, power consumption and/or performance. However, using the inventive patch antenna 500 according to the present disclosure as part of the dial plate 130 will mitigate at least some of these project risks.

The first step may be to decide the structure of the dial plate 130. Since the design requirements specify a plastic dial plate 130 this will have to be the part of the dial plate 130 visible through the transparent face 140. Covered by this, an NFC coil and an antenna is required as per the design requirements. The order of the materials of the dial plate 130 would be, as seen from the transparent face, a plastic dial plate, an NFC coil, a galvanically isolating material and a patch antenna 500. Since the NFC coil might be detuned by the close proximity of the patch antenna 500, the galvanically isolating material may be chosen to be an isolating material adapted to redirect electromagnetic flux such as a ferrite material and preferably a ferrite material with a peak in permeability around the operating frequency of the NFC chosen for the project.

The next step could be deciding the feed method of the patch antenna. The requirements, the ISM-band, specify that the lowest operating frequency f of the patch antenna 500 is 2400 MHz. This band is 100 MHz wide and in order not to impair the bandwidth of the patch antenna, a coupling element 1100 implemented as a capacitive coupling element 1100 may be chosen. A direct feed may also be considered but that would be more appropriate if the bandwidth was closer to 0.5% of a center frequency as opposed to the 4% of this design example (100 MHz/2450 MHz).

Since the casing 110 is specified to be of a conductive material, isolation is desired between the patch antenna 500 and the casing 110. This could be achieved by introducing a gap 1300 between the casing 110 and the patch antenna 500. From empirical experience a gap size of 0.7 mm could be chosen which puts a constraint on the radius of the patch antenna R₂ of 14.7−0.7 mm=14.0 mm.

After reading this disclosure, using the second face B of the patch antenna 500 as the second conductive coupling patch of the coupling element 1100, makes sense due to the requirement to limit the number of components of the hybrid watch 100. Dimensioning the capacitive feed would mean maximizing a capacitive coupling coefficient of the coupling element 1100 or simplified, minimizing the impedance Z of the coupler by, for instance, the usage of the relationship presented in Eqn. 3. The impedance is reversely dependent on the area A and increases with the distance d. The maximum area A is limited to the area of the patch and the distance d needs to be controlled. In a first attempt, the conductive coupling patch 1110 could be chosen to be of for instance a copper foil. A dial plate carrier 1410 of a rather cheap formable plastic is chosen, say polystyrene, the relative permittivity is about 2.55 and from Eqn. 3 the distance d should be less than 0.2 mm in order to have an absolute impedance of the coupler of less than 1.0Ω. Having a controlled distance d of 0.2 mm or less may not be feasible and one option is changing the material of the dial plate carrier 1410 to one with a higher relative permittivity, this would decrease the impedance Z or allow for and increased distance d. Alternatively, and preferably, the conductive coupling patch 1110 could be placed between the dial plate carrier 1410 and the patch antenna 500, with just a thin, e.g. less than 100 μm, layer of isolating material as the distance d. This is achieved by e.g. using an FPC for the conductive coupling patch with an insulating sheet arranged at least on the second face 1210 of the conductive coupling patch 1110, the one facing the second face B of the patch antenna 500. The insulating sheet may be a polyimide sheet and have a dielectric constant of around 3.0. This would further reduce the impedance Z and may reduce the complexity of the dial plate carrier 1410.

The first coupling terminal 1040 could be implemented as a RF spring connecting to a gold plated area of the first face 1140 of the first conductive coupling patch 1110. The gold plated area could be implemented in order to reduce the risk of oxidation and ensure a good connection between the first coupling terminal 1040 and the first face 1140 of the first conductive coupling patch 1110.

1. A patch antenna (500) for a hybrid watch (100), the hybrid watch (100) comprising a casing (110), a transparent face (140) and an electronics assembly (120) comprising a radio frequency interface (1020) and a first coupling terminal (1040), the casing (110) being made of a material with a dielectric constant larger than 1.0; and
wherein the patch antenna (500) comprises a conductive material and has a first face (T) and an opposing second face (B), and the patch antenna (500) is adapted to be arranged inside the casing (110) of the hybrid watch (100) such that a plane of the faces (T, B) of the patch antenna (500) is substantially parallel with a plane of the transparent face (140), and the first face (T) of the patch antenna (500) is facing the transparent face (140);
wherein the first coupling terminal (1040) is connected to the radio frequency interface (1020) of the hybrid watch (100); and
wherein the second face (B) of the patch antenna (500) comprises a second coupling terminal (1130) adapted to couple, via a coupling element (1100), to the first coupling terminal (1040).

2. The patch antenna (500) of claim 1, wherein the first face (T) of the patch antenna (500) is comprised in a dial plate (130).

3. The patch antenna (500) of claim 1, wherein the first face (T) of the patch antenna (500) is a dial plate (130).

4. The patch antenna (500) of claim 1, wherein
the first and the second coupling terminals (1040, 1130) are terminals of the coupling element (1100), wherein the coupling is capacitive, and the second face (B) of the patch antenna (500) is the second coupling terminal (1130) of the coupling element (1100).

5. The patch antenna (500) of claim 4 wherein the first coupling terminal (1040) is further connected to a conductive coupling patch (1110) with a first face (1140) and a second face (1210) wherein the second face (1210) is substantially parallel to and is facing the second face (B) of the patch antenna (500).

6. The patch antenna (500) claim 1, wherein the casing (110) of the hybrid watch (100) is conductive and the patch antenna (500) is adapted to be arranged inside the casing (110) such that a gap (1300) is formed between the conductive material of the patch antenna (500) and the casing (110) so that the conductive material of the patch antenna (500) is galvanically isolated from the casing (110), and the gap (1300) forms a radiating slot between the casing (110) and the conductive material of the patch antenna (500).

7. The patch antenna (500) of claim 6, wherein the gap (1300) comprises a material with a dielectric constant larger than 1.0.

8. The patch antenna (500) of claim 6, wherein the width of the gap (1300) is in the range of 0.3 mm to 1.3 mm, preferably 0.4 mm to 1.2 mm, and most preferably 0.5 mm to 1.0 mm.

9. The patch antenna (500) of any of claim 1, wherein the patch antenna (500) further comprises an NFC coil (900) and at least one galvanically isolating material interposed between the first side (T) of the patch antenna (500) and the NFC coil (900).

10. The patch antenna (500) of claim 9, wherein the galvanically isolating material is a ferrite material.

11. A hybrid watch (100) comprising at least one transparent face (140), a casing (110), wherein the casing (110) is comprised of a material with a dielectric constant larger than 1.0 and the casing houses an electronics assembly (120), a dial plate (130) and a coupling element (1100) with a first coupling terminal (1040) and a second coupling terminal (1130); wherein the arrangement is such that one face of the dial plate (130) is, at least partly, visible through the transparent face (140); and
wherein the electronics assembly (120) comprises a radio frequency interface (1020) connected to the first coupling terminal (1040) of the coupling element (1100); and
wherein the dial plate (130) comprises a patch antenna (500) having a first face (T) and an opposing second face (B) wherein the patch antenna (500) is arranged to have the first face (T) arranged towards the transparent face (140) and wherein the second face (B) of the patch antenna (500) comprises the second coupling terminal (1130) of the coupling element (1100).

12. The hybrid watch (100) of claim 11, wherein the coupling element (1100) is a capacitive coupling element (1100) and further comprises a conductive coupling patch (1110) with a first face (1140) and a second face (1210), the conductive coupling patch (1110) is arranged between the patch antenna (500) and the electronics assembly (120) such that the second face (1210) of the coupling patch (1110) is substantially parallel to and is facing the second face (B) of the patch antenna (500) and the first face of the coupling patch (1110) is connected to the first coupling terminal (1040).

13. The hybrid watch (100) of claim 11, wherein the dial plate (130) is the patch antenna (500).

14. The hybrid watch (100) of claim 11, further comprising an impedance matching circuitry (1030) arranged between the radio frequency interface (1020) and the first coupling terminal (1040).

15. The hybrid watch (100) of claim 11, wherein the casing (110) of the hybrid watch (100) is conductive and the patch antenna (500) is arranged inside the casing (110) such that a gap (1300) is formed between the patch antenna (500) and the casing (110) so that the patch antenna (500) is galvanically isolated from the casing (110), and the gap (1300) forms a radiating slot between the casing (110) and the patch antenna (500).

16. The hybrid watch (100) of claim 15, wherein the electronics assembly (120) is arranged inside the casing (110) such that the gap (1300) is also formed between the electronics assembly (120) and the casing (110) so that the electronics assembly (120) is galvanically isolated from the casing (110).

17. The hybrid watch (100) of claim 15, wherein the gap (1300) comprises a material with a dielectric constant larger than 1.0.

18. The hybrid watch (100) of claim 15, wherein the width of the gap (1300) is in the range of 0.3 mm to 1.3 mm, preferably 0.4 mm to 1.2 mm, and most preferably 0.5 mm to 1.0 mm.

19. The hybrid watch (100) of claim 11, wherein the patch antenna (500) further comprises an NFC coil (900) and at least one galvanically isolating material interposed between the first side (T) of the patch antenna (500) and the NFC coil (900).

20. The hybrid watch (100) of claim 19, wherein the galvanically isolating material is a ferrite material.
